(19) United States
(12) Patent Application Publication
(10) Pub. No.: US 2002/0116276 A1
(43) Pub. Date: Aug. 22, 2002

(54) Intuitive graphical user interface for dynamically addressing electronic shopping cart deliverables

(76) Inventor: Steven R. Ottley, Fairport, NY (US)

Correspondence Address: NIXON & VANDERHYE P.C.,, 1100 North Glebe Rd. 8th Floor, Arlington, VA, 22201-4714, US

(21) Appl. No.: 09/785,247

(22) Filed: Feb. 20, 2001

(51) Int. Cl. G06F 17/60

(52) U.S. Cl. 705/26

(57) ABSTRACT

A graphical user interface (GUI) for an electronic commerce ordering system displays product shipment information (e.g., return address, ship-to address and shipping method) bundled together into an image that mimics a traditional mailing envelope, shipping label or shipping package. A web-based view displays the “return address,” “shipping method” and “ship-to address” at positions where such information would traditionally appear on a traditional envelope or shipping package. This format is easily understood by a user as most users addressing an envelope. Dynanic fields displayed in the envelope-based graphical user interface can be made to be easily modifiable.

### FIELD OF THE INVENTION

The invention relates electronic commerce graphical user interfaces, and more particularly, to computer graphical user interfaces that facilitate data entry of shipping information. In more detail, the present invention relates to a web-based dynamic shopping cart providing a browser view of a deliverable object to facilitate data entry and/or confirmation of shipping instructions such as ship-to address, ship-from address and/or delivery method.

### BACKGROUND AND SUMMARY OF THE INVENTION

The Internet is now well established as a useful way to support business-to-consumer transactions. All kinds of goods are being offered for sale over the World Wide Web. Consumers can shop the world from the convenience of their den or office using a web-enabled appliance, an Internet connection and a credit card.

Commonly, a consumer will direct his or her web browser to the online catalog or store front he or she wishes to order goods from. Various web browser views are presented showing the goods available for sale. An electronic shopping cart allows the consumer to order multiple products during the same overall web session. At the conclusion of shopping, the consumer is prompted to input ship-to address information and payment information (e.g., credit card number) to complete the transaction. It is common for the online merchant's web site to present the consumer, during online checkout, with a web browser form having a number of fillable fields corresponding to name, address, telephone number, e-mail address, etc. Often, some of these fields are mandatory whereas other fields are optional. There may be limitations on the contents of various fields (e.g., length, capitalization, etc.). Once the consumer has filled out the form, the consumer's web appliance sends the form back to the merchant's web site where the inputted information is stripped out and stored into a database. The database contents are then accessed by a fulfillment center to print out a shipping label for the package to be sent to the consumer.

Most consumers who have attempted such online transactions have usually been successful but may have become somewhat frustrated by the clumsiness of the data entry user interface. One of the problems relates to verifying the accuracy of the information inputted by the consumer. To minimize the possibility of using incorrect information, merchant web sites often check and verify the filled-in field contents. If the information inputted by the consumer is incomplete or doesn't match the consumer's credit card information, the merchant's web site may refer the already-completed form back to the consumer and request the consumer to operate the “back” button his or her browser to provide the additional or corrected information. Such error handling interrupts the flow of the transaction and can be quite disconcerting and intimidating to consumers who expected their transaction to be completed and instead are presented with annoying computer-generated error messages and requests for further data entry After a few unsuccessful attempts, less technically adept consumers may give up trying to use the World Wide Web to order the goods—either resorting to calling the merchant on the telephone or giving up entirely and instead obtaining the goods from a local store instead of from the online merchant.

While much work has been done in the past in attempts to make electronic commerce transactions easier to initiate and perform, further improvements are possible and desirable. For example, the requirement that the consumer must correct fill out a form so that the electronic commerce provider can correctly address an envelope or package is not exactly the most intuitive process for a consumer to follow. It would be highly desirable to provide a more user-friendly, more intuitive graphical user interface for inputting and/or verifying shipping information in the context of a dynamic electronic shopping cart and/or in other electronic commerce contexts.

The present invention solves this problem by providing a new graphical user interface (GUI) for an electronic commerce ordering system that displays product and/or service delivery information (e.g., shipping information such as return address, ship-to address and shipping method) bundled together into an image that mimics a traditional mailing envelope, shipping label, shipping package or other deliverable object.

In accordance with one aspect provided by this invention, a web-based view displays a traditional postal envelope with “return address,” “shipping method” and “ship-to address” dynamic fields at positions where such information would traditionally appear on a traditional envelope. This format is easily understood by a user as most users associate the graphical display with the traditional methodology of addressing an envelope.

Dynamic fields displayed in the envelope-based graphical user interface can be made to be easily modifiable. For example, by clicking or otherwise selecting an “edit envelope” link, the graphical user interface functionality can take the user to the “shipping address” page where the user can re-enter information and have it dynamically populated back into the shopping cart.

The resulting electronic display format is easily understood by a user since it allows him or her to associate the graphical display with traditional methodology used for addressing a package or an envelope. Furthermore, the information from the database can be used to address any sort of a shipping label—e.g., a label that does not look at all like the envelope displayed in the graphical user interface.

Additionally, the user can easily view shopping basket/bag/cart with multiple variable ordering combinations. Each section may contain detailed information about the particular product(s) being ordered. The product(s) can be bundled together in individual sections with their shipping method(s) associated with each order. All of the dynamic information can be editable and updateable.

In one example embodiment, the traditional mailing envelope user interface display is provided in a Java-enabled HTML format so it can be displayed within a conventional web browser having a Java virtual machine. In one advantageous embodiment, a form including user input address fields is displayed on a web browser view along with an image of the envelope or package to be addresses. The web page can be Java enabled so that as the user inputs address information into the fields, the page automatically populates the associated envelope/package view with the inputted information. Since the user knows intuitively how to address an envelope or package and has done it many times before, the user can immediately detect data entry problems such as missing or erroneous information. The user can thus readily verify the inputted information himself or herself before submitting it to the merchant's web site and associated shopping cart.

The graphical user interface provided by the invention can, in one advantageous embodiment, be used to order greeting cards that an electronic commerce web site can offer for automatic dispatch to one or more recipients. For example, the consumer can use the graphical user interface to specify his or her own return address, the mailing address of the recipient(s), and shipping method (e.g., first class mail). Of course, in other embodiments, the graphical user interface can be used to address virtually any sort of item to be delivered to a recipient using any mechanism (including but not limited to US Postal Service, other common carrier, or by electronic means).

The invention can be used for all sorts of applications including but not limited to:

electronic commerce,

greeting cards,

posters,

books,

compact disks,

computer software,

any product shipped by envelope, parcel or package,

computers,

any electronics,

any other type of goods or services,

any application or use where a destination or recipient is specified.

### BRIEF DESCRIPTION OF THE DRAWINGS

These and other features and advantages provided by the invention will be better and more completely understood by referring to the following detailed description of presently preferred embodiments in conjunction with the following drawings:

FIG. 1 shows an example preferred embodiment of a goods fulfillment system 100 provided by the present invention;

FIG. 2 shows an example graphical user interface 200 provided in accordance with the present invention;

FIG. 3 shows an example flow chart of steps performed by the FIG. 1 preferred embodiment;

FIGS. 4A-4H show one example progression of display screens;

FIGS. 5A-5D show a further example progression of display screens;

FIGS. 5E-5G shows a further example display screen progression; and

FIGS. 6A-6B show display screens for parcel shipment.

### DETAILED DESCRIPTION OF EXAMPLE EMBODIMENTS OF THE INVENTION

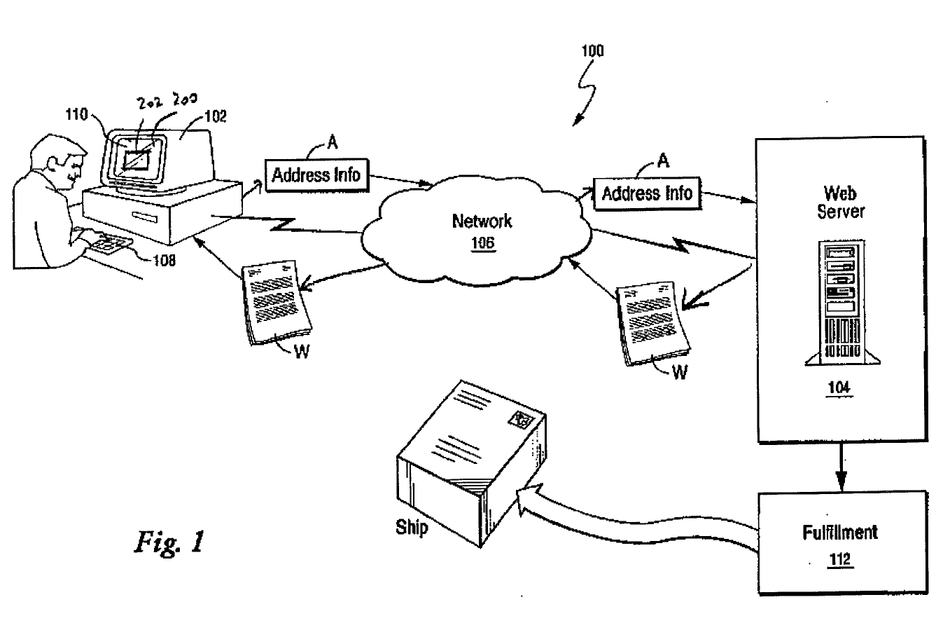

FIG. 1 shows an example preferred embodiment of an electronic commerce goods ordering and fulfillment system 100 provided by the present invention. System 100 includes any number of end user stations 102 coupled to one or more servers 104 via a network 106 such as, for example, the Internet, an enterprise intranet, or other network. End user workstations 102 may comprise any type of computing or data entry appliance but preferably are web-enabled in the sense that they preferably provide a web browser that can receive and display web pages W supplied by server 104 via network 106.

End user workstation 102 includes a data entry device 108 (e.g., keyboard, a mouse pointing device or the like) that allows an end user to input data into web-based forms providing a graphical user interface 200 displayed on a display 110. For example, the end user can input ship-to and return address information into workstation 102 via graphical user interface 200. HTTP messages containing this address information A can be transmitted over network 106 to server 104. Server 104, in turn, may store the address information A in a database and, upon the end user confirming an order for goods, may communicate the address information (and goods identification if appropriate) to a fulfillment system 112.

In the example embodiment, fulfillment system 112 creates a shipping package labeled with the specified ship-to and return address information and releases the package to a common carrier (e.g., the U.S. Postal Service, Federal Express, United Parcel Service, electronic distribution, etc.) for delivery to the ship-to address specified by the end user.

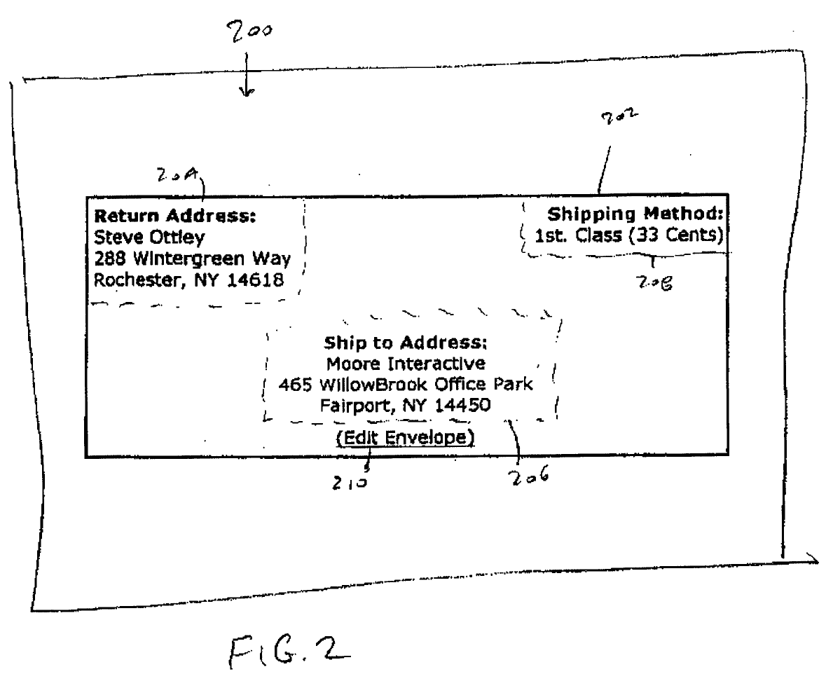

Preferred embodiment system 100 includes a unique and advantageous graphical user interface (GUI) 200 that the end user can use to specify shipping information. FIG. 2 shows an example graphical user interface 200 provided in accordance with the present invention. Example graphical user interface 200 provides an image 202 of a deliverable object including dynamic areas 204, 206, 208. For example, image 202 may representing an envelope or other shipping container or package. Image 202 may, for example, resemble quite closely the actual package that the end user desires to have sent out—or it may look entirely different from the actual package (for example, the image 202 could be of an envelope whereas the item to be shipped might need to be packaged within a box or parcel). In one example embodiment, image 202 comprises a white rectangle resembling a No. 10 business envelope.

In the example embodiment, image 202 includes a return address dynamic dynamic area 204, a ship-to address dynamic dynamic area 206 and a shipping method dynamic dynamic area 208. In the example embodiment, the ship-to address dynamic dynamic area 206, return address dynamic dynamic area 204 and shipping method dynamic dynamic area 202 may be positioned on the envelope image 202 in the same places they would occur on an actual envelope or other shipping package (e.g., with the return address dynamic dynamic area 204 in the upper left-hand corner of the envelope, the ship-to address dynamic dynamic area 206 in the center of the envelope, and the shipping method dynamic dynamic area 208 in the upper right-hand corner of the envelope). The return address dynamic area 204 provides return address information. The ship-to address dynamic area provides information as to where the package is to be shipped (e.g., name of person or entity, corporate name if applicable, street address, suite or apartment number if applicable, city, state, country, province and zip or other postal code). The shipping method dynamic area 202 provides information concerning the method of shipment (e.g., overnight, first class, other class, bulk, etc.) and may also include cost information for the particular shipping method that is chosen.

As FIG. 2 shows, graphical user interface 200 is extremely intuitive and easy to use because it is designed to resemble a postal envelope to package a product that is ordered over the Internet and then mailed. Looking at graphical user interface 200, the end user will instantly be able to detect any errors because the end user has typically many times addressed his or her own envelopes and/or seen envelopes addressed to him or her. The intuitive nature of graphic user interface 200 allows easy error spotting, avoids confusion and complexity, and provides a readily-understandable and easy-to-use interface for an electronic commerce, product ordering, mass mailing or other underlying fulfillment functionality.

As shown in FIG. 2, graphical user interface 200 may include an “edit” command field 210 (e.g., a hypertext link, button, or other mechanism) by which the end user can ask to edit the information within dynamic areas 202, 204, and/or 206. If any of the information within dynamic areas 202, 204, 206 is inaccurate or incomplete, the end user may enter the “edit” command to change or add to that information.

In one example embodiment, the end user does not actually enter information into the envelope image 202. Rather, the user inputs information into conventional fillable fields within a web page W. The server 104 (or, in one particular advantageous embodiment, a Java applet delivered with the web page W and running on the end user's device 102 under a Java virtual machine) takes the filled-in contents of the fields and uses it to populate the graphical user interface envelope image 202. In this way, the end user can input information into the types of fillable fields that server 104 and its associated ecommerce functionality may require for storage to a database, but can obtain graphical feedback that the inputted information is correct and error-free by viewing the envelope image as the user is inputting information into the fields and/or after the user has inputted information into the fields. In the event the user has inputted wrong or incomplete information, the user will instantly see the error by viewing the graphical user interface 202, and can click on the “edit envelope” hypertext link to provide the correct information.

In one example embodiment, the user may provide the return address, ship-to address and shipping method using different fillable field forms. In this particular embodiment, the graphical user interface 202 may display the return address dynamic area 204 while the user is inputting the return address information; display the ship-to address dynamic area 206 while the user is inputting the ship-to address information; and display the shipping method information dynamic area 208 while the user is selecting shipping method and cost. The user may then be presented with a complete image 202 with all dynamic areas 204, 206, 208 filled in so the user can confirm that all of this information is correct. If the user detects an error, the user can ask to edit the information. Once the user has finished editing the information, system 100 can display a corrected, updated graphical user interface 202 for the user to review and confirm.

Example Greeting Card Distribution Embodiment

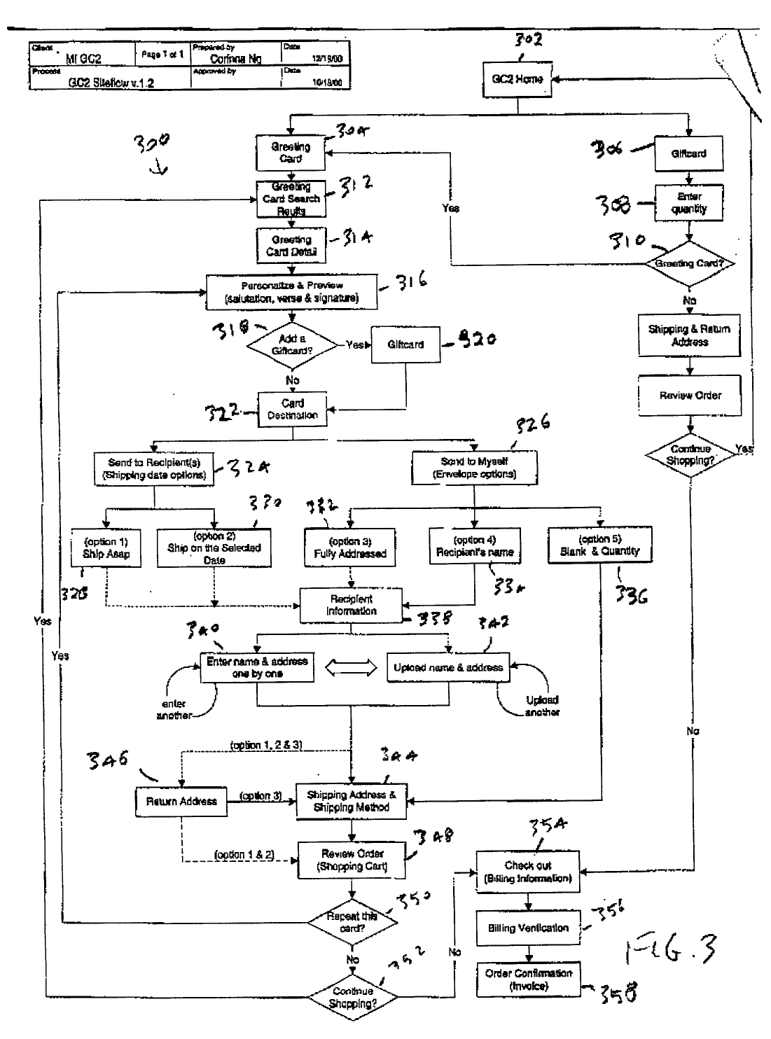

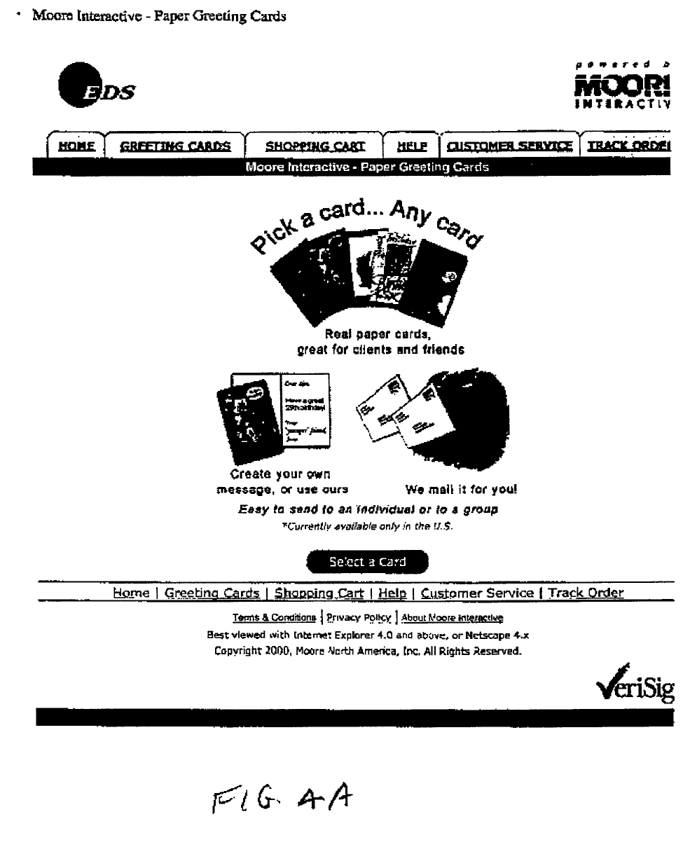

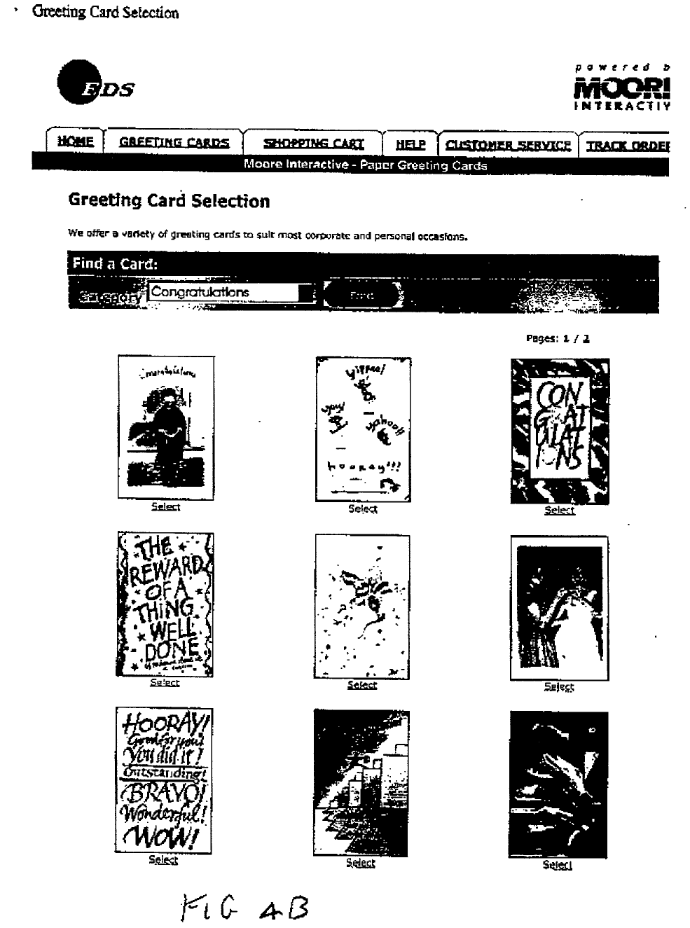

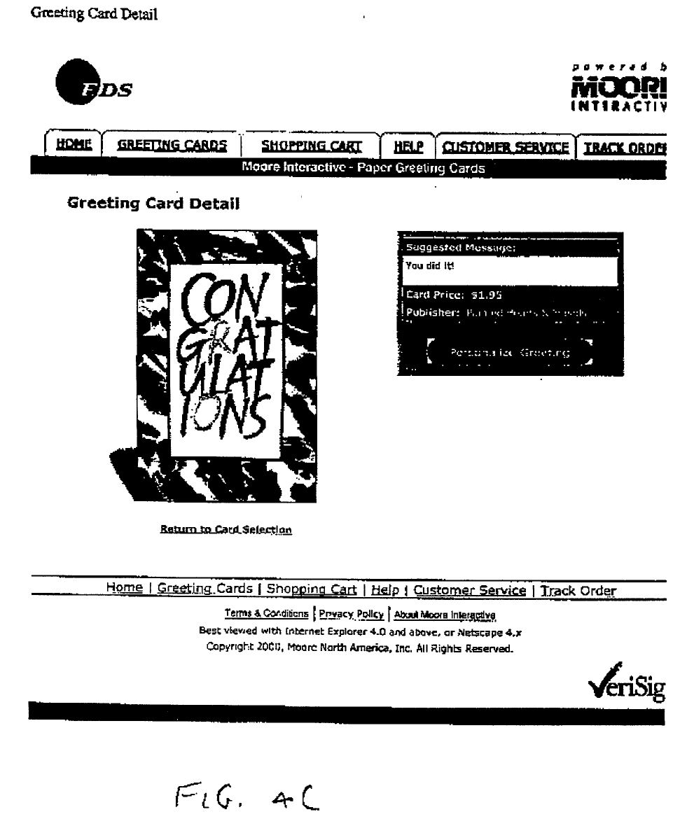

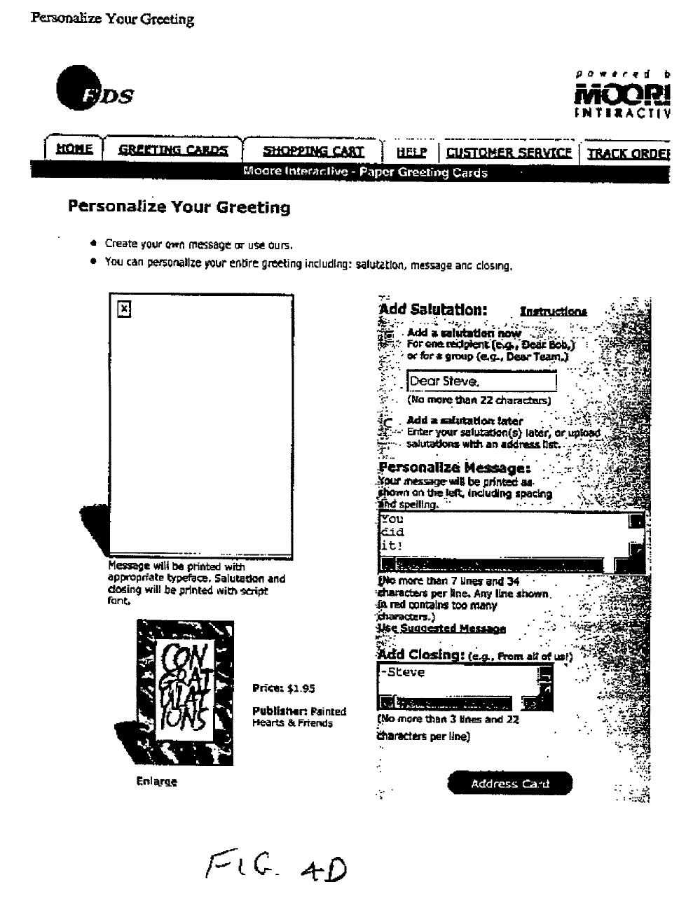

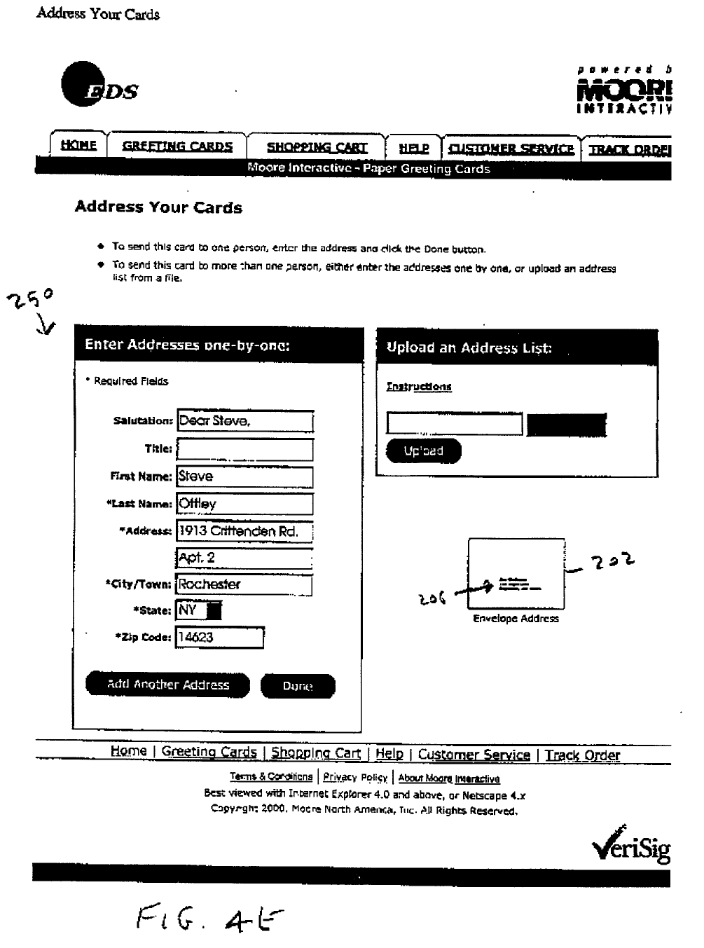

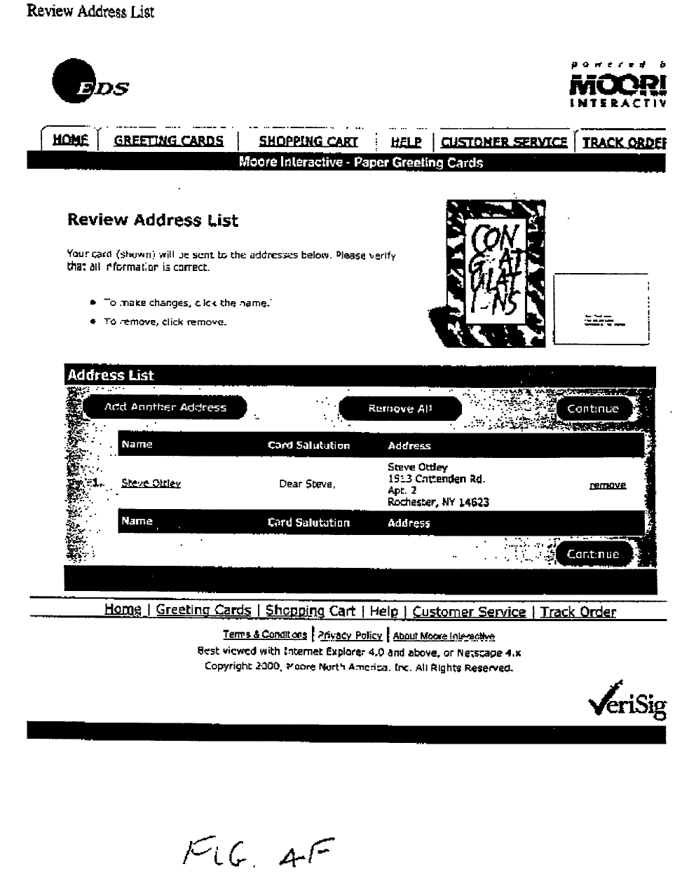

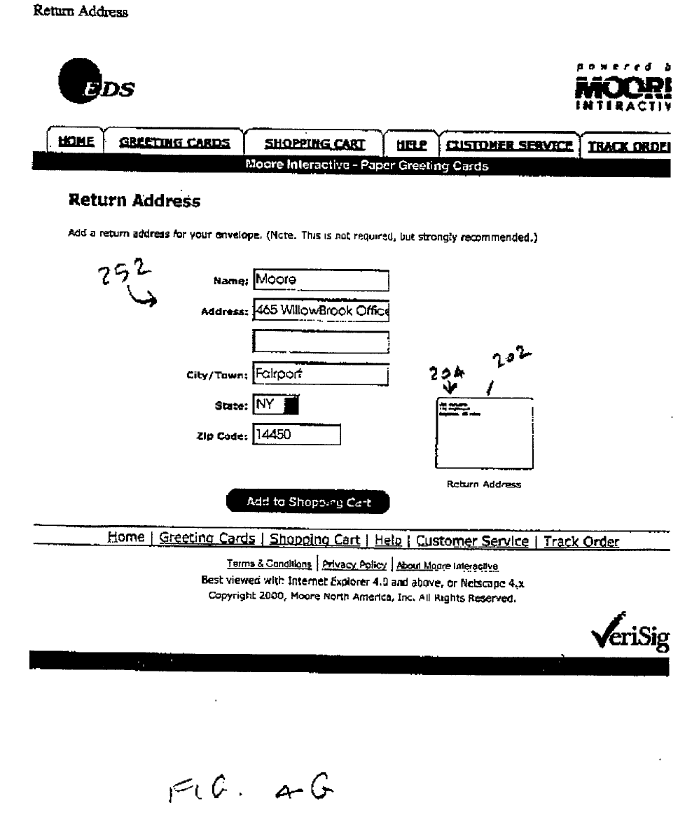

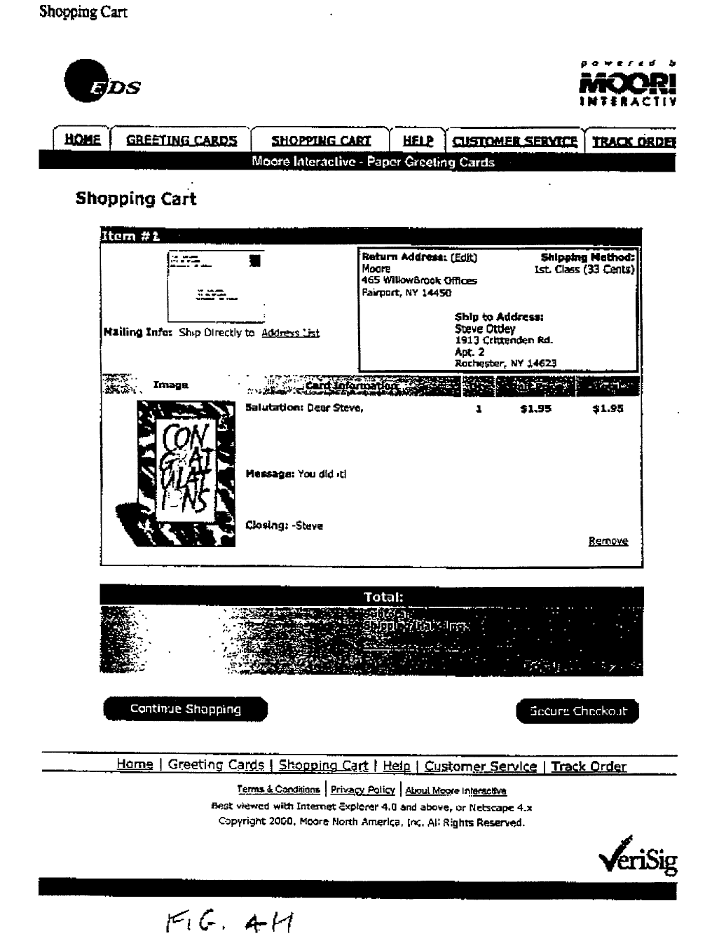

FIG. 3 shows an example flow chart of steps performed by a particular preferred example embodiment used to order and distribute greeting cards, and FIGS. 4A-4H show an example sequence of user interface web pages W that system 100 may present to step a user through a greeting card ordering transaction. Using this particular example embodiment, the end user shown in FIG. 1 can request server 104 to generate and mail a greeting card addressed from the user to a specified recipient or recipients.

As shown in FIG. 3, the end user may first interface with a home page (block 302; see FIG. 4A) and from there select a greeting card or gift card option (block 304, block 306). If the end user selects a gift card option (block 306), the user may be prompted to enter the quantity of cards to mail (block 308) and they may be asked whether the card is going to be a greeting card (decision block 310) If the user selects a greeting card (“yes” exit to decision block 310), control is passed to block 304 where the user may be given the option to search among different greeting cards available (block 312; see FIG. 4B). Once the user has selected a particular greeting card, he or she may then be shown a particular selected greeting card detail (block 314; see FIG. 4C) and may be given the option to personalize and preview the particular card (e.g., by inputting the salutation, verse or other message, and/or signature line) (block 316; see FIG. 4D). The user may then be prompted for additional options (e.g., whether or not to add an additional gift card) (block 318, block 320), before being asked to specify the destination (block 322).

To specify ship-to destination, the user may select between sending to recipients or to himself or herself (block 324, block 326). If the user chooses to send to one or more recipients (block 324), the user may be permitted to specify whether a shipment is to go out right away (block 328) or on a particular selected date (block 330). If the user wants the package to be sent to himself or herself (block 326), the user may select between different options, such as, for example, having the item fully addressed (block 332), simply indicating the recipient's name (block 334), or blank (block 336).

With all of these options, at some point the user is prompted to specify recipient information (block 338; see FIG. 4E). In the preferred embodiment, the user may enter names and addresses one by one (only a single name and address for one recipient, or multiple names and associated addresses for multiple recipients) (block 340). Another option the preferred embodiment allows is to upload a file including names and addresses (block 342). Irrespective how the user inputs the recipient name and address information, the preferred embodiment displays a graphical user interface as shown in FIG. 4E including an html form including fillable fields prompting the user to input first name, last name, address, city/town, state and zip code (and/or other or additional information for international shipping). See form 250 shown in FIG. 4E. In the example embodiment, the same web page that displays ship-to address data entry form 250 may also provide a display of the envelope-based GUI image 202 of the type shown in FIG. 2 with ship-to address dynamic area 206. As the user inputs information into form 250, the information can be populated into envelope image 202 to allow the user to verify that the ship-to address he or she has inputted is correct.

In one particular embodiment, the web page W is Java-enabled (i.e., it is delivered with a Java applet) that completes the envelope image 202 as the user inputs information into the fields of form 250. In this example embodiment, the user can instantly receive visual feedback concerning the correctness of the information he or she has inputted into form 250. In another embodiment (and/or if the user is using a browser that is not Java-enabled), the user can request a “refresh” that sends the fields of form 250 to server 104 and the server can send an updated web page that populates the envelope image 202 with the address information the user has inputted.

Once the user verifies the ship-to address, the preferred embodiment may then allow the user to verify the number of card to be shipped (see FIG. 4F). The user may then be asked to input a return address (block 346, see FIG. 4G). In one example embodiment as shown in FIG. 4G, server 104 sends the user a return-address web page including a fillable field data entry form 252 and an envelope-based image 202 including a corresponding populated return-address dynamic area 204 so the user can verify the correctness of the return address information he or she is providing.

The user may also be asked to specify shipping method if more than one shipping method is available. Upon specifying the shipping method and return address, the server 104 may send the user a web page (see FIG. 4H) that includes the entire graphical user interface 200 shown in FIG. 2 including envelope-based image 202 wherein all of the dynamic areas 204, 206, 208 are populated—allowing the user to see the entirety of the information he or she has inputted in one compact, intuitive image. The user may then be asked to review the information to make sure it is correct. If the user has made an error, he or she can correct it by requesting an “edit” function (see FIG. 2, link 210) and can be shown some or all of the previous data entry screens and given an opportunity to re-enter incorrect information.

Once the user has reviewed and verified the graphical user interface 200 (block 348), the user may be given the option to repeat to continue shopping (block 350, 352). Once the user is finished shopping, the user may check out (block 354) and provide conventional billing information which may be verified and confirmed using a conventional ecommerce engine of known design (blocks 356, 358).

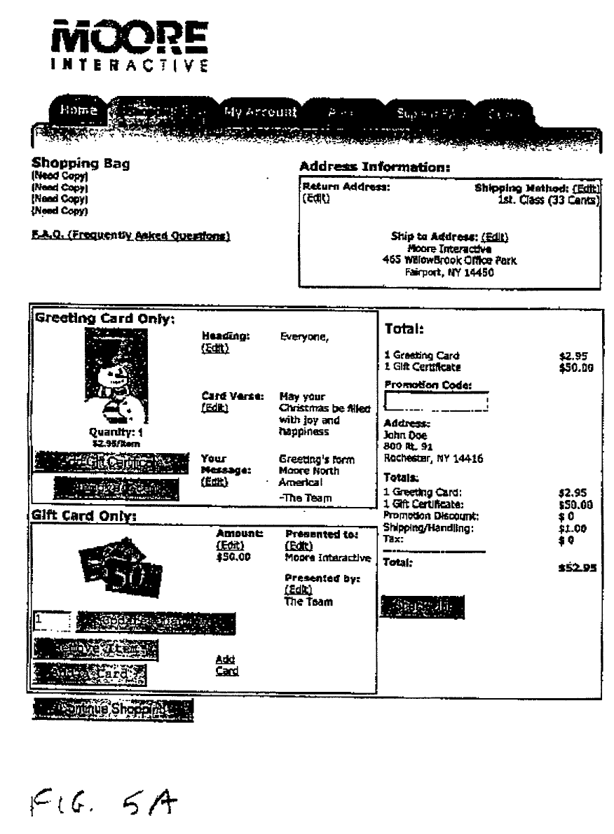

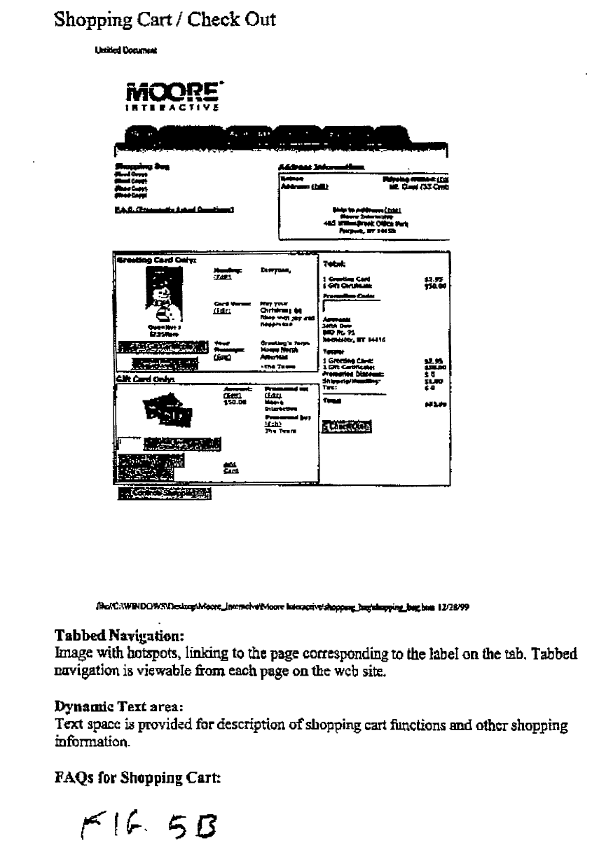

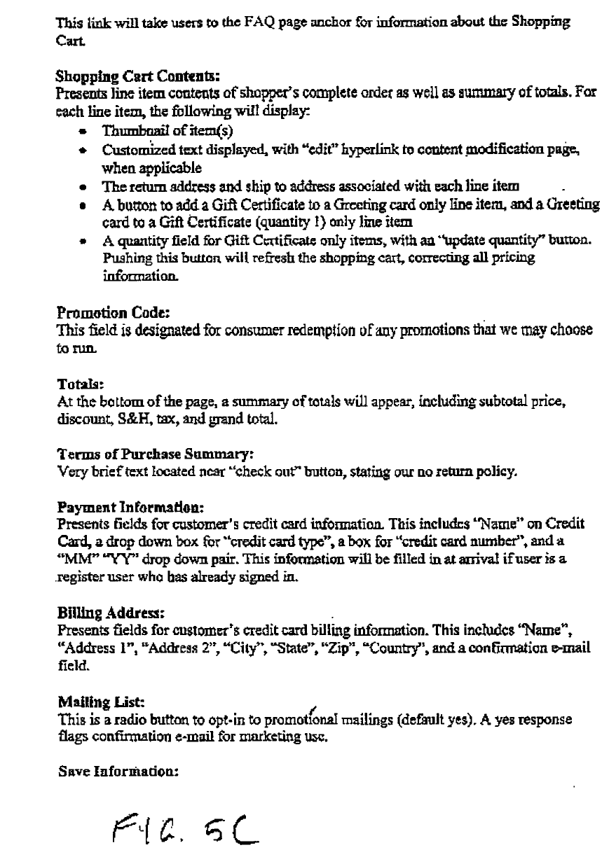

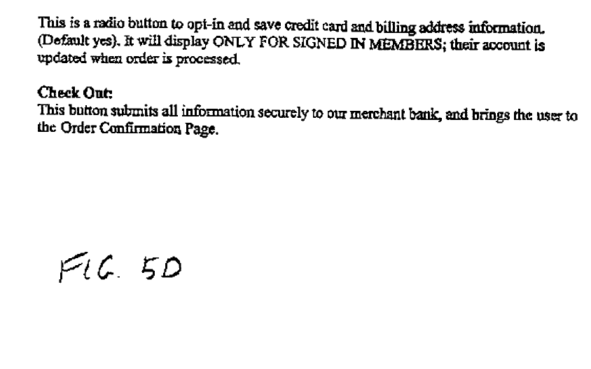

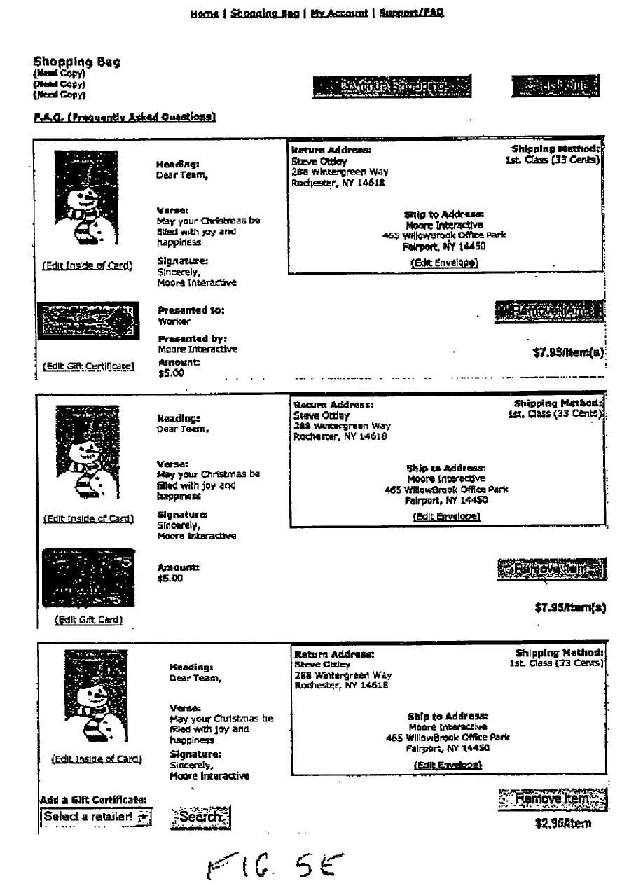

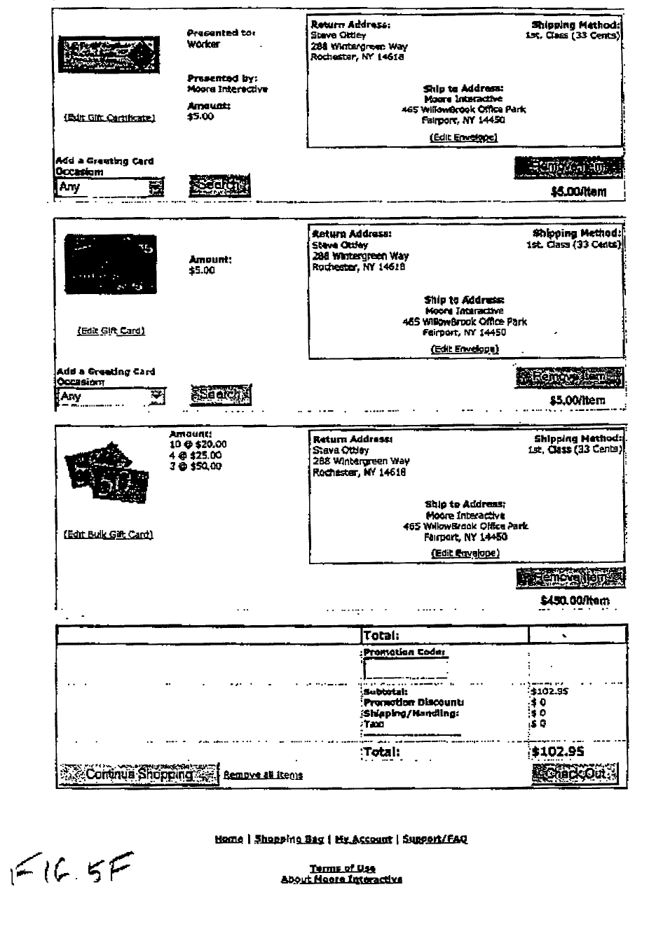

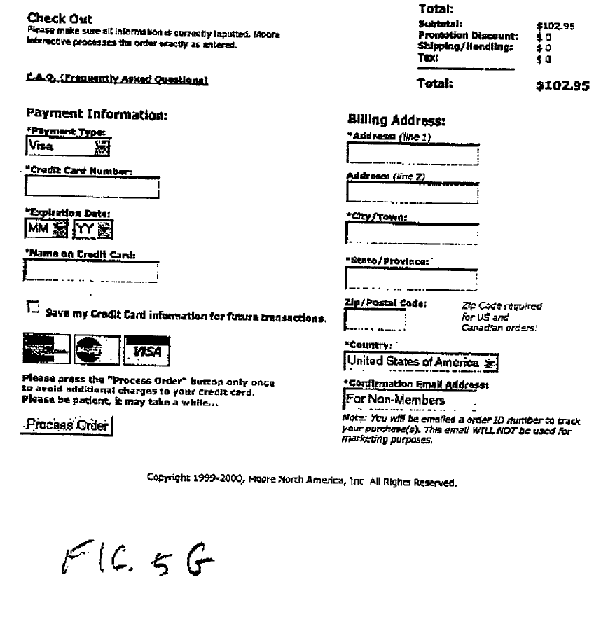

FIGS. 5A-5D show a variation of the screen progressions shown in FIGS. 4A-4H using the same basic graphical user interface envelope-based image 202. In the FIG. 5A example, each one of dynamic areas 204, 206, 208 includes its own “edit” link/button to allow the user to request editing/updating of these various dynamic areas on an individualized basis. FIGS. 5E-5G show yet another example screen progression embodiment for ordering greeting cards.

Example Package Shipment

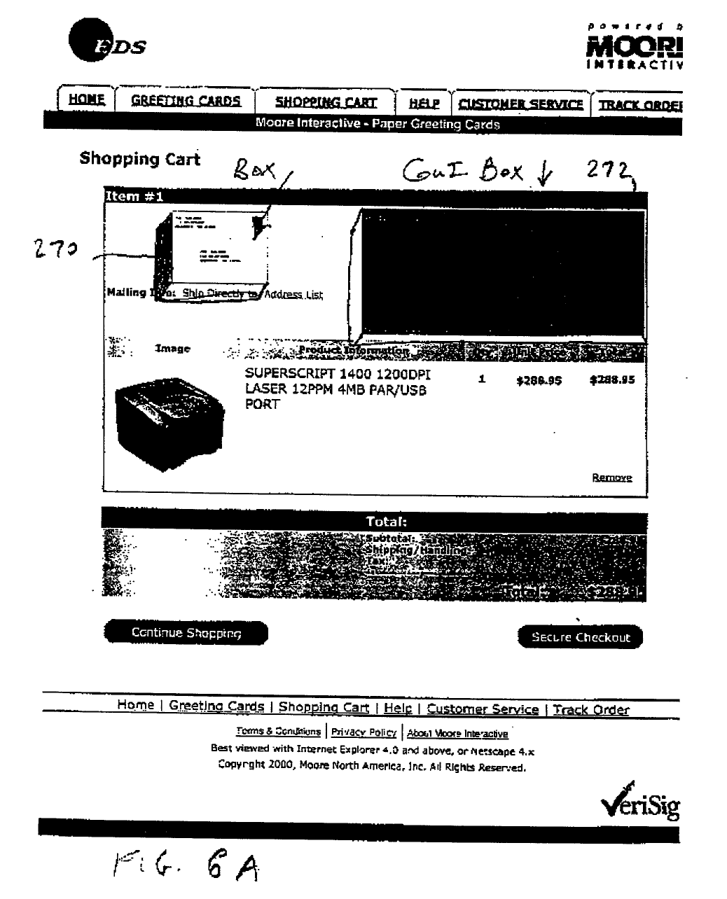

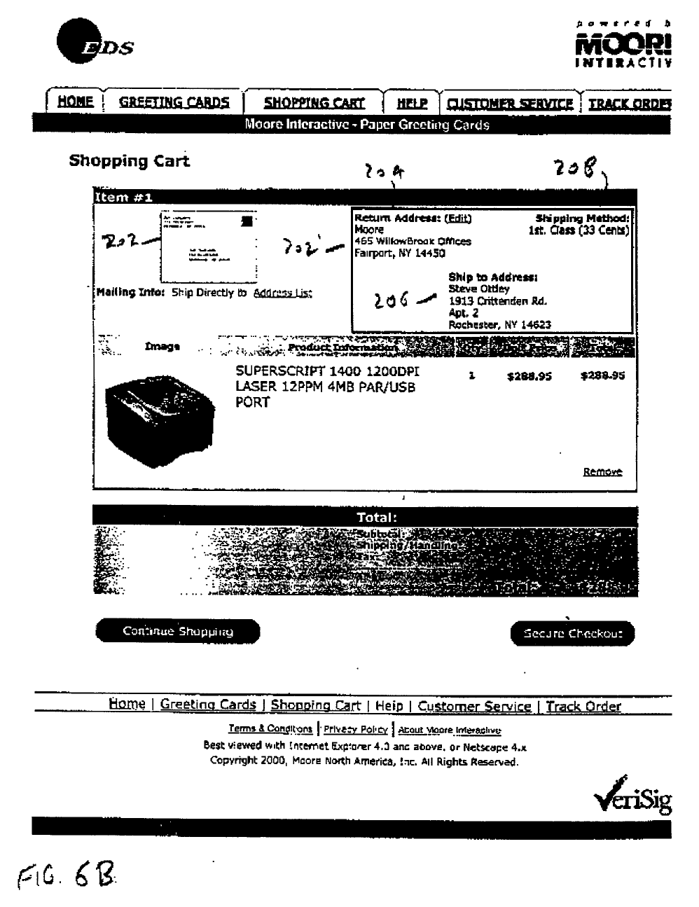

FIG. 6A shows another example embodiment of the present invention that can be used to ship any type of item including for example, computers, books, any electronics or any other type of goods. In this example embodiment, the graphical user interface 200 is designed to resemble a box to package a product that's ordered over the Internet and then mailed or otherwise physically delivered. In this example embodiment, graphical user interface 200 can present an image 270, 272 of a parcel or package with corresponding return-address dynamic area 204, ship-to address dynamic area 206 and shipping method dynamic area 210. In this example, the shipping method dynamic area 210 might include express mail, overnight delivery, UPS, Federal Express, courier, or any other way to deliver a parcel or package.

FIG. 6B shows yet another example embodiment wherein the envelope-based image 202 of FIG. 2 is used to display shipping information that will eventually find its way onto a shipping label to be applied to a carton, parcel or box. In this particular example, the envelope-based image 202 continues to provide an intuitive, easy-to-understand user interface display—but the information once received and stored by server 104 is printed onto some object other than an envelope (e.g., a parcel address label or onto a parcel itself). Thus, in this example embodiment, the graphical user interface 200 displays an image of one type of deliverable object to allow the user to visualize the addressing of that object, whereas the information is then actually applied to a different type of deliverable object altogether.

While the invention has been described in connection with what is presently considered to be the most practical and preferred embodiment, it is to be understood that the invention is not to be limited to the disclosed embodiment. For example, although the preferred embodiments have been described in connection with the ordering and delivery of goods over the Internet or other network, other variations are possible. As one example, the graphical user interface 200 might be used to specify the recipient of any type of good or service (e.g., the home addresses of recipients of service calls or visits). As another example, the graphical user interface 200 could be used as part of a stand-alone system or software package (e.g., a word processing package or mailing label system) to make it easier to input and verify shipping information. Thus, rather than being limited to the particular disclosed embodiments, the present invention is intended to cover various modifications and equivalent arrangements included within the scope of the claims.

We claim:

1. A graphical user interface for facilitating the inputting and/or verification of shipping information into an electronic commerce system over the Internet, said graphical user interface comprising:
a browser-based display area displaying an image representing a deliverable object, said image including at least a ship-to dynamic display area displaying a desired recipient's address,
wherein the dynamic display area is automatically populated with previously inputted recipient information and is presented for verification/correction.

2. An interface as in claim 1 wherein the dynamic display area includes an edit selector.

3. The interface of claim 1 wherein the deliverable object comprises a postal envelope.

4. The interface of claim 1 wherein the deliverable object comprises a package.

5. The interface of claim 1 further including a fillable form and an applet that automatically, dynamically populates said area in response to data entry into the fillable form.

6. The interface of claim 1 wherein the image further including a return address area and a shipping method area.

7. The interface of claim 1 wherein the image represents a deliverable object different from one that will be delivered to the recipient.

8. The interface of claim 1 wherein the interface is Java enabled.

9. The interface of claim 1 wherein the area is dynamically populated from a database.

10. An electronic commerce system comprising:
a server that delivers, over a network, at least one web page including an envelope-based image including a ship-to dynamic area, a return address dynamic area, and a shipping method dynamic area, said server populating said area with pre-stored information;
the server providing an edit function that allows an end user to correct the information displayed in any of the areas; and
a fulfillment processor that uses the corrected information to address a deliverable object for delivery to a recipient displayed in the ship-to dynamic area using the shipping method specified in the shipping method dynamic area.

11. The system of claim 10 wherein the deliverable object comprises a parcel.

12. The system of claim 10 wherein the deliverable object comprises an envelope.

13. The system of claim 10 wherein the deliverable object comprises a greeting card envelope.

14. The system of claim 10 wherein said server downloads an applet that dynamically populates at least some of said areas in response to user input into fields of an HTML form.

15. A method of specifying delivery information for a deliverable object comprising:
inputting at least recipient information into a computer system;
displaying, with the computer system, an image of a deliverable object including a ship-to address dynamic area including said inputted recipient information;
permitting editing of the dynamic area;
verifying the recipient information based on said image display; and
conditioned on said verifying step, creating and shipping the same or different deliverable object addressed to the ship-to address.
